(19) United States
(12) Patent Application Publication
(10) Pub. No.: US 2011/0064852 A1
(43) Pub. Date: Mar. 17, 2011

(54) PORTION CAPSULE AND USE OF A PORTION CAPSULE

(75) Inventor: Torsten MANN, Meerbusch (DE)

(73) Assignee: KRUGER GMBH & CO. KG, Bergisch-Gladbach (DE)

(21) Appl. No.: 12/885,017

(22) Filed: Sep. 17, 2010

Related U.S. Application Data
(60) Provisional application No. 61/243,414, filed on Sep. 17, 2009.

(30) Foreign Application Priority Data
Sep. 17, 2009 (DE) 102009041633.1

(51) Int. Cl. B65B 29/02; A23L 2/52

(52) U.S. Cl. 426/78; 426/431

(57) ABSTRACT

Proposed is a portion capsule for producing a beverage, having a substantially frustoconical or cylindrical base element which has a cavity, and having a membrane which closes off the cavity, with a filter element being arranged within the cavity, which filter element divides the cavity into a first region for holding beverage raw material and a second region for holding a beverage extract, with the filter element being fastened to the base element by at least one fastening means which is arranged substantially in the region of a side, which is situated opposite the membrane, of the base element.

### BACKGROUND

The present invention relates to a portion capsule for producing a beverage, having a substantially frustoconical or cylindrical base element which has a cavity, and having a membrane which closes off the cavity, with a filter element being arranged within the cavity, which filter element divides the cavity into a first region for holding beverage raw material and a second region for holding a beverage extract.

Such portion capsules are generally known. For example, the document FR 2 556 323 A1 discloses a portion capsule which has a frustoconical or cylindrical base element and which is used for producing a beverage, with the first region of the cavity within the portion capsule being filled with beverage raw material, in particular coffee powder. To produce a coffee beverage, the portion capsule is arranged in a brewing chamber in which the membrane is perforated and an extraction liquid, in particular hot water, is introduced into the first region. The extraction liquid flows through the beverage raw material, so as to form a beverage extract, in particular a coffee beverage, which passes through the filter element into the second region of the cavity. By means of the sieve function of the filter element, the beverage raw material is prevented from passing into the second region. In the brewing chamber, a bottom region of the portion capsule is also perforated such that the beverage extract can leave the portion capsule and pass, if appropriate, into a beverage receptacle, such as for example a coffee cup.

A disadvantage of said portion capsule is that the filter element is not fixedly connected to the base element, and a relative movement between the filter element and the base element is therefore possible. Therefore, in particular during the transportation and storage of the portion capsules, the possibility of the filter element slipping out of place cannot be ruled out. Furthermore, modern coffee extraction machines operate at relatively high pressures, as a result of which there is the risk of the filter element in the portion capsule being washed upwards or floating upwards during the injection of the extraction liquid into the first region. Such displacements of the filter element could lead to the beverage raw material passing around the filter element from the first region into the second region. During production of the beverage, said beverage raw material is subsequently conducted into the beverage receptacle, thereby impairing the quality of the beverage. In the case of coffee powder, for example, being used as a beverage raw material, this results in an undesired bitter taste of the coffee beverage, and residues of the raw coffee material can be found in the beverage receptacle.

It is therefore the object of the present invention to fasten the filter element so as to effectively prevent a relative movement between the base element and the portion capsule. In this way, the beverage raw material is prevented from passing from the first region into the second region and thereby impairing the taste and appearance of the beverage to be produced.

### SUMMARY OF THE INVENTION

The object is achieved by means of a portion capsule for producing a beverage, having a substantially frustoconical or cylindrical base element which has a cavity, and having a membrane which closes off the cavity, with a filter element being arranged within the cavity, which filter element divides the cavity into a first region for holding beverage raw material and a second region for holding a beverage extract, with the filter element also being fastened to the base element by at least one fastening means which is arranged substantially in the region of a side, which is situated opposite the membrane, of the base element.

The portion capsule according to the invention has the advantage over the portion capsule according to the prior art that the filter element is fixedly connected to the base element. Firstly, therefore, the portion capsule is considerably less susceptible to being shaken and to the action of external force, for example during storage or transportation, and secondly, extraction under considerably higher pressures is made possible. The risk of the beverage which is produced from the portion capsule being contaminated with beverage raw material is reduced, and an improvement is therefore obtained in the quality of the beverage produced. Here, the fastening means is arranged in particular on a side which is situated opposite the membrane along a direction perpendicular to a main plane of extent of the membrane. Said side of the base element is also referred to hereinafter as the bottom region. That surface of the filter element which faces towards the beverage raw material and through which in particular filter openings extend is referred to hereinafter as the filter surface.

Advantageous embodiments and refinements of the invention emerge from the subclaims and from the description with reference to the drawings.

According to a preferred refinement, it is provided that the base element has a groove, with the fastening means comprising an engagement element which engages into the groove in a non-positively locking, positively locking and/or materially joined fashion. It is therefore advantageously possible to realize between the filter element and the base element a connection which is comparatively simple to produce and which is cost-effective and also stable.

According to a preferred refinement, it is provided that the groove is formed in a wall and/or in a bottom region of the base element. Depending on the requirements on the volume ratios between the first and second regions, the groove is preferably formed in the region of the wall or in the bottom region. An arrangement of the groove in the bottom region has the result, for example, that the first region can be designed to be of relatively large volume. The arrangement of the groove in the region of the wall also has the advantage that the groove and/or the fastening element can simultaneously function as a reinforcement element for the wall. The bottom region preferably comprises a region, which is arranged opposite the membrane perpendicular to the main plane of extent, of the base element. It is alternatively also conceivable for the bottom region and the membrane to be interchanged.

According to a preferred refinement, it is provided that a latching and/or click-in connection is formed between the engagement element and the groove. This advantageously does not increase the assembly expenditure during the production of the portion capsule according to the invention in relation to the portion capsule without fastening means according to the prior art. During the production process, the filter element is preferably merely placed into the cavity such that the latching or click-in connection is automatically formed. For example, a comparatively low pressure in the direction of the bottom region is exerted on the filter element as it is placed into the cavity, such that the engagement element automatically passes into engagement with the groove. The engagement element is in particular of encircling design along the circumference of the filter element. It is alternatively provided that the filter element has a multiplicity of engagement elements which are arranged distributed over the circumference of the filter element and spaced apart from one another along the circumference.

According to a preferred refinement, it is provided that the engagement element extends perpendicular to a main plane of extent of the filter element substantially over the entire height of the groove, with the groove preferably extending to the bottom region. The filter element is thereby advantageously fixed perpendicular to the main plane of extent of the filter element, both with respect to a movement in the direction of the bottom region and also with respect to a movement directed away from the bottom region. The filter element is particularly advantageously fixed by the fastening means preferably in a position in which the filter element is spaced apart from the bottom region. Damage to the filter element during a perforation and/or a piercing of the bottom region in the brewing chamber is therefore prevented. It is particularly preferable for only the edge regions of the filter element to extend perpendicular to the main plane of extent over the entire groove width and to simultaneously rest on the bottom region, such that the edge regions enable particularly stable support of the filter element in the bottom region.

According to a preferred refinement, it is provided that an undercut is formed in the region, which undercut is engaged behind by the engagement element, such that a connection which is easy to produce and mechanically stable can be realized in a simple manner. As a result of the engagement of the engagement element behind the undercut, positive locking is generated between the undercut and the engagement element, as a result of which a detachment of the engagement element from the groove is prevented.

According to a preferred refinement, it is provided that the cross section of the groove is substantially round or angular. The latching of the engagement element in a groove with an angular cross section is advantageously comparatively stable and precise. In contrast, a groove with a round cross section facilitates the mounting of the filter element in the base element, and provides self-centring of the engagement element in the groove. It is also conceivable for the groove to have a U-shaped and/or V-shaped cross section. In a particularly preferred embodiment, the groove has an insertion bevel on one side, as a result of which the engagement automatically slides into the groove during assembly.

In a preferred refinement, it is provided that the engagement element is pressed into the groove. The engagement is preferably pressed into the groove such that a permanent and non-detachable connection is formed between the filter element and the base element. In this case, the engagement element functions in particular as a rivet.

In a preferred refinement, it is provided that the engagement element is releasably connected to the groove. The filter element can thereby advantageously be removed from the base element again, such that at least the base element can be re-used, for example. In particular, a filter element which has become blocked by the beverage raw material during the extraction process can thereby in a simple manner be removed from a used portion capsule and replaced with a new filter element. The engagement element is preferably integrally connected to the filter surface, with the filter element being formed in particular as an injection-moulded part from a thermoplastic, preferably polypropylene. The base element preferably comprises a plastic material which is soft in relation to the filter element.

In a preferred refinement, it is provided that the fastening means are formed in the encircling edge region of the filter element, with a bead being formed between the fastening means and a filter surface of the filter element. The bead advantageously makes possible an elastic deflection movement of the fastening means, in particular of the engagement element, relative to the rest of the filter element, that is to say in particular relative to the filter surface. The engagement element therefore preferably engages in the manner of a tongue-and-groove connection into the groove. The fastening element is preferably pressed by the wall of the base element along the radial direction in the direction of the filter surface, as a result of which frictional engagement is produced between the base element and the fastening means and/or a non-positively locking and positively locking connection is produced between the groove and the engagement element.

In a preferred refinement, it is provided that the bead extends perpendicular to the main plane of extent to the bottom region and/or that the bead has a U-shaped or V-shaped cross section, such that comparatively good deflection behaviour of the fastening means relative to the filter surface is advantageously obtained.

In a preferred refinement, it is provided that the fastening means comprise a welded connection and/or an adhesive connection. The filter element is advantageously welded and/or adhesively bonded to the base element such that a comparatively stable materially joined connection is generated between the base element and the filter element. The welded connection is produced for example by means of ultrasound welding, friction welding, vibration welding, laser welding, cold pressure welding and/or spot welding.

According to a further subject matter or a preferred refinement of the present invention, it is provided that the filter element comprises a reinforcement element. The reinforcement element advantageously serves to stiffen at least the filter surface of the filter element. In modern coffee machines, the extraction liquid is increasingly introduced into the first region of the portion capsule at comparatively high pressures, for example at pressures of between 10 and 20 bar. Furthermore, during the arrangement of the portion capsule, the beverage raw material is in part intensely compressed, because for example the consistency and the crema (brown foam on the surface of an espresso) of a coffee are significantly dependent on the compression of the beverage raw material before the extraction. Relatively large forces perpendicular to the main plane of extent therefore act on the filter element. In the portion capsule according to the invention, said forces are absorbed by the reinforcement element, such that bending or rupturing of the filter surface in the direction of the second region is prevented. The filter element preferably comprises an injection-moulded part composed of plastic, with the reinforcement element preferably being formed in one piece with the filter surface.

In a preferred refinement, it is provided that the reinforcement element extends at least partially along a main plane of extent of the filter element, such that the filter surface is advantageously stiffened at least over a significant partial region. The reinforcement element preferably comprises, in a plane parallel to the main plane of extent, a beam structure, a ring structure and/or an areal element.

In a preferred refinement, it is provided that the reinforcement element is arranged perpendicular to the main plane of extent between a filter surface of the filter element and a bottom region of the base element. The volume of the second region available for the beverage raw material is therefore advantageously not reduced by the reinforcement element. The reinforcement element functions in particular as a foundation for the filter surface. It is however alternatively also conceivable for the filter surface to be arranged between the reinforcement element and the bottom region.

In a preferred refinement, it is provided that the reinforcement element comprises reinforcement struts which preferably extend substantially parallel to the main plane of extent. Here, the reinforcement struts advantageously function as support beams for supporting the filter surface. The reinforcement struts preferably comprise a flat profile, hollow profile, I-shaped profile, L-shaped profile, C-shaped profile, Z-shaped profile, T-shaped profile and/or double-T-shaped profile. An optimization of the mechanical loadability of the filter element is therefore advantageously obtained with the least possible material usage.

In a preferred refinement, it is provided that the reinforcement struts are arranged so as to run in a radial direction of the filter surface, and in particular in a crossed or star-shaped configuration, in a plane parallel to the main plane of extent. The reinforcement struts therefore run preferably in the radial direction of the filter element. In a preferred embodiment, the reinforcement struts are fixedly and in particular integrally connected to the engagement element or to a multiplicity of engagement elements along the circumference of the filter element.

In a preferred refinement, it is provided that the reinforcement struts and/or sides, which face towards the bottom region, of the reinforcement struts are formed so as to be curved relative to the main plane of extent, and are formed in particular as an arch structure. An arch structure is advantageously comparatively stable in relation to a flat support structure with regard to forces acting perpendicular to the main plane of extent, because such forces generate only compressive stresses in an arch structure. The portion capsule according to the invention is therefore of relatively stable design, wherein at the same time the required material usage can be considerably reduced, and cost advantages can therefore be obtained in the production of the portion capsule.

According to a further subject matter or a preferred refinement of the present invention, it is provided that a spacing of between 1 millimetre and 10 millimetres, preferably of between 3 millimetres and 7 millimetres, and particularly preferably of substantially 5 millimetres, is provided between the filter element and the bottom region perpendicular to a main plane of extent of the membrane. Such spacings between the filter element, that is to say in particular the filter surface, and the bottom region advantageously lead to a considerably more turbulent and swirled flow of the beverage extract in the second region in comparison with the prior art. This leads to a relatively good thorough mixture of the beverage extract and to the enrichment of the beverage extract with the air situated in the second region. The taste and the consistency of the beverage to be produced, which comprises in particular coffee, are positively influenced by this swirled flow of the beverage extract. The crema formation on the coffee is particularly preferably promoted in this way.

According to a further subject matter or a preferred refinement of the present invention, it is provided that the spacing between the filter element and the bottom region perpendicular to a main plane of extent of the membrane amounts to between 2 and 40 percent, preferably to between 9 and 28 percent and particularly preferably to substantially 16 percent of the cross section of the filter element parallel to the main plane of extent. The spacing between the filter region and the bottom region, and the cross section of the filter element, are decisive for the geometry of the second region. Here, it has been found that the ratio between the spacing and the cross section of the filter element is also decisive for the intensity of the swirling of the beverage extract in the second region. The abovementioned percentage ratios between spacing and cross section advantageously generate a particularly swirled and turbulent flow of the beverage extract in the second region, as a result of which at the same time the advantages already stated above can be obtained with regard to the quality of the beverage to be produced.

According to a further subject matter or a preferred refinement of the present invention, it is provided that the filter element has support structures which are provided for spacing the filter element apart from a bottom region of the base element. Damage to the filter element during the perforation or during a piercing process is advantageously prevented by the spacing of the filter element apart from the bottom region perpendicular to the main plane of extent. At the same time, the forces acting on the filter element perpendicular to the main plane of extent are transmitted directly by the support structures to the bottom region, such that the stability of the filter element with respect to said forces can be considerably increased. Additional stiffening structures can therefore advantageously be dispensed with. In a preferred embodiment, to increase stability, the filter element comprises both stiffening structures and support structures. The stiffening and support structures are optionally formed in one piece in a common structure.

In a preferred refinement, it is provided that the support structures are formed as a multiplicity of columns which extend perpendicular to a main plane of extent from the filter, fastening and/or reinforcement element to the bottom region. The filter surface is thereby advantageously supported directly on the bottom region. Forming the support structures as a multiplicity of columns also has the advantage that the flow of the beverage extract in the second region is influenced only to an insignificant extent by the support structures. In particular, the intense swirling of the beverage extract in the second region is not adversely affected.

In a preferred refinement, it is provided that the columns are arranged in a uniform, in particular annular, crossed and/or star-shaped pattern, and/or non-uniformly, in a plane parallel to the main plane of extent. The filter surface is thereby advantageously supported by columns at a multiplicity of points along the main plane of extent. Here, the swirl generation in the beverage extract in the section region is promoted by a non-uniform distribution of the columns.

In a preferred refinement, it is provided that the filter element has a central depression. The bottom region of a puncturing stem projects into said depression during the perforation or during the piercing of the bottom region, such that direct contact between the filter element and the puncturing stem is advantageously prevented. In particular, damage to the filter surface by the puncturing stem is prevented.

According to a further subject matter or a preferred refinement of the present invention, it is provided that the filter element or at least one side, which faces towards a bottom region of the base element, of the filter element is formed so as to be arched relative to a plane parallel to the main plane of extent. According to a further subject matter or a preferred refinement of the present invention, it is provided that the filter element or at least that side of the filter element which faces towards the bottom region is formed as part of an ellipsoidal shell or spherical shell. The filter element or at least that side of the filter element which faces towards the bottom region is accordingly of similar design to an arch structure. An arch structure is advantageously more stable than a flat support structure with respect to forces acting perpendicularly on the arch structure, because such forces generate only compressive stresses in an arch structure. A design of the filter element or of at least one side of the filter element as an arch structure therefore has the advantage that the filter element can be relatively highly loaded with regard to forces acting on the filter element perpendicularly to the main plane of extent. This enables an intense compression of the beverage raw material in the hollow chamber and an introduction of the extraction liquid into the first region at a relatively high pressure, wherein at the same time the required material usage and therefore the production costs of the portion capsule can be minimized. The forces exerted on the filter element by the beverage raw material or the injected extraction liquid generate only compressive stresses. Furthermore, an arch structure has the advantage that the flow behaviour of the beverage extract in the section region is not influenced or is influenced only to an insignificant extent. In a preferred embodiment, the entire filter element is formed, in particular the filter element is formed over its entire material thickness, as an arch structure for example in the form of a semi-dome. This has the advantage that the material thickness of the filter surface, in particular in the region of the filter openings formed in the filter surface, is substantially constant. In this way, the length of filter ducts which are defined by the filter openings in the filter surface and which extend perpendicular to the filter surface and/or to the bottom surface is virtually constant over the entire filter surface, such that the flow resistance is also virtually constant for all the filter openings. This permits a comparatively uniform flow of the extraction liquid through the beverage raw material. In another preferred embodiment, it is provided that only the side facing toward the bottom region is formed as an arch structure, that is to say so as to be curved, while a side, which faces away from the bottom region, of the filter element is formed substantially as a planar surface. This has the advantage that the amount of beverage raw material is preferably constant over the entire cross section of the portion capsule.

According to a further subject matter or a preferred refinement of the present invention, it is provided that the filter element has a multiplicity of filter openings which in each case define filter ducts extending through the filter element perpendicular to the filter surface, with the lengths of the filter ducts perpendicular to the filter surface increasing outwardly in the radial direction. This advantageously enables that side of the filter element which faces towards the bottom region to be formed as an arch structure, while that side of the filter element which faces away from the bottom region is formed as a planar surface. Alternatively, the filter ducts extend perpendicular to that side of the filter element which faces towards the bottom region, such that all the filter ducts have a virtual common point of intersection. The filter ducts therefore function as a collecting organ and conduct the beverage extract to the centre of the bottom region. A central perforation of the bottom region is preferably provided in the brewing chamber, such that the beverage extract is deflected by the filter element directly to the outlet opening (perforation) of the second region.

According to a further subject matter or a preferred refinement of the present invention, it is provided that the filter element is of substantially round design parallel to the main plane of extent and has a multiplicity of filter openings, with the cross sections of the filter openings increasing outwardly in the radial direction. Compensation of the filter ducts which increase in length outwardly in the radial direction is therefore advantageously possible. The filter ducts which increase in length outwardly have the effect that the flow resistance increases outwardly in the radial direction. This is compensated in that the cross sections of the filter openings are formed so as to increase in size outwardly, such that a reduction of the flow resistance is simultaneously generated outwardly in this way. The flow resistance is advantageously virtually constant overall along the radial direction, such that a uniform extraction of the extraction liquid through the beverage raw material is obtained.

According to a further subject matter or a preferred refinement of the present invention, it is provided that the filter element has a multiplicity of filter openings, with the frequency of the filter openings increasing outwardly along the radial direction. To obtain as constant as possible a flow resistance along the radial direction, an increasing frequency of the filter openings is realized outwardly along the radial direction. This has the effect that the flow resistance which increases outwardly on account of the increasing lengths of the filter ducts is compensated, and overall, a constant flow resistance along the radial direction is advantageously obtained, which ensures a uniform flow through the beverage raw material.

According to a further subject matter or a preferred refinement of the present invention, it is provided that the filter element has a multiplicity of filter openings which are formed such that the sum of the cross sections of the filter openings amounts to between 0.1 and 10 percent, particularly preferably between 1 and 3 percent and particularly preferably substantially 1.4 percent of the entire cross section of the filter element. This ratio, which is comparatively low in relation to the prior art, between the total hole area and the overall filter surface area has the effect that the flow resistance of the filter openings is relatively high. The beverage extract therefore flows through the filter openings or through the filter ducts at a considerably higher speed, such that considerably more intense swirling and more turbulent flows of the beverage extract are generated in the second region. The comparatively small hole cross sections lead in particular to the beverage extract emerging from the filter openings or the filter ducts in the second region in the manner of liquid jets (that is to say as substantially centred liquid jets), with the liquid jets impinging at high speed on the bottom region and being deflected or reflected back in the direction of the filter element. The beverage extract which flows in the second region in the direction of the perforation opening therefore preferably performs upward and downward movements at the same time. Said flow behaviour is preferably promoted by the abovementioned spacings between the filter element and the bottom region. Such movement patterns advantageously lead to a considerably more turbulent and swirled flow of the beverage extract in the second region in relation to the prior art. This leads to a comparatively good thorough mixture of the beverage extract and to the enrichment of the beverage extract with the air situated in the second region. The taste and the consistency of the beverage to be produced, which comprises in particular coffee, are positively influenced by this swirled flow of the beverage extract. The crema formation on the coffee is particularly preferably promoted in this way.

According to a further subject matter or a preferred refinement of the present invention, it is provided that the filter element has a multiplicity of filter openings, with the cross sections of the filter openings being in each case of substantially round design and varying along a direction perpendicular to the main plane of extent. The discharge of the beverage extract from the filter openings or from the filter ducts into the second region at high speed and in particular in the form of liquid jets is advantageously promoted in this way, as a result of which the beverage extract is intensely swirled in the second region, and the abovementioned advantages are obtained.

In a preferred refinement, it is provided that the filter openings in each case define filter ducts extending through the filter element perpendicular to the filter surface, with the cross sections of the filter ducts being in each case of substantially constant design in a first partial region, and in each case changing along the direction perpendicular to the filter surface in a second partial region. It is preferably provided here that the second partial region is arranged on a side, which faces towards the bottom region, of the filter element, and/or that the cross section of the filter openings and/or of the filter ducts increases in size in the direction of the bottom region. The variation of the cross sections and in particular the increase in size of the cross section in the direction of the bottom region likewise ensure an increase in the swirl formation in the second region.

According to a further subject matter or a preferred refinement of the present invention, it is provided that the filter element has a multiplicity of filter openings, with a mean diameter of the filter openings of between 100 and 1000 micrometres, preferably of between 300 and 700 micrometres and particularly preferably of substantially 400 micrometres being provided at least on a side, which faces towards the membrane, of the filter element. It has been found that such diameters lead to a considerable optimization of the swirl formation in the second region and therefore to a considerable improvement in quality of the beverage to be produced.

According to a further subject matter or a preferred refinement of the present invention, it is provided that the filter element has a multiplicity of filter openings, with the filter openings having a mean diameter of between 800 and 1200 micrometres on a side facing towards the bottom region, and a mean cross section of between 300 and 700 micrometres on a side facing away from the bottom region. It has been found that such diameters lead to a considerable optimization of the swirl formation in the second region and therefore to a considerable improvement in quality of the beverage to be produced.

According to a further subject matter or a preferred refinement of the present invention, it is provided that the filter element has a multiplicity of filter openings, with the filter openings having, at least on a side facing towards the membrane, a mean diameter which amounts to between 40 and 400 percent, preferably to between 55 and 135 percent and particularly preferably to substantially 80 percent of the spacing between the filter element and the bottom region perpendicular to a main plane of extent of the membrane. It has been found that such a percentage ratio between the diameters of the filter openings and the mean spacing between the filter element, in particular the filter surface, and the bottom region maximize the swirl formation in the second region, as a result of which a considerable increase in quality of the beverage to be produced is obtained, as already discussed in detail above.

A further subject matter of the present invention is the use of a portion capsule according to the invention for producing a beverage.

The beverage raw material comprises in particular coffee powder, chocolate powder, milk powder or the like.

Exemplary embodiments of the invention are illustrated in the figures and are explained in more detail in the following description. The figures are described merely by way of an example, and do not restrict the general concept of the invention.

### BRIEF DESCRIPTION OF THE FIGURES

FIG. 1 shows a schematic, side-on sectional view of a portion capsule according to a first embodiment of the present invention,

FIG. 2 shows a schematic, side-on sectional view of a portion capsule according to a second embodiment of the present invention,

FIGS. 3a, 3b show schematic, side-on sectional views of a portion capsule according to a third embodiment of the present invention,

FIG. 4 shows a schematic, side-on sectional view of a portion capsule according to a fourth embodiment of the present invention,

FIG. 5 shows a schematic, side-on sectional view of a portion capsule according to a fifth embodiment of the present invention,

FIG. 6 shows a schematic, side-on sectional view of a portion capsule according to a sixth embodiment of the present invention,

FIG. 7 shows a schematic plan view of the reinforcement structures of a filter element of a portion capsule according to a seventh embodiment of the present invention,

FIG. 8 shows a schematic, side-on sectional view of a portion capsule according to the seventh embodiment of the present invention,

FIG. 9 shows a schematic, side-on sectional view of a portion capsule according to an eighth embodiment of the present invention,

FIG. 10 shows a schematic plan view of a filter element of a portion capsule according to the eighth embodiment of the present invention,

FIG. 11 shows a schematic plan view of a filter element of a portion capsule according to a ninth embodiment of the present invention,

FIG. 12 shows a schematic, side-on sectional view of a portion capsule according to a tenth embodiment of the present invention,

FIG. 13 shows a schematic, side-on sectional view of a portion capsule according to an eleventh embodiment of the present invention,

FIG. 14 shows a schematic, side-on sectional view of a portion capsule according to a twelfth embodiment of the present invention,

FIG. 15 shows a schematic plan view of a filter element of a portion capsule according to a thirteenth embodiment of the present invention,

FIG. 16 shows a schematic, side-on sectional view of a portion capsule according to a fourteenth embodiment of the present invention and

FIG. 17 shows a schematic, side-on sectional view of a portion capsule according to a fifteenth embodiment of the present invention.

In the various figures, the same parts are always denoted by the same reference numerals, and are therefore generally also each specified or mentioned only once.

### DETAILED DESCRIPTION

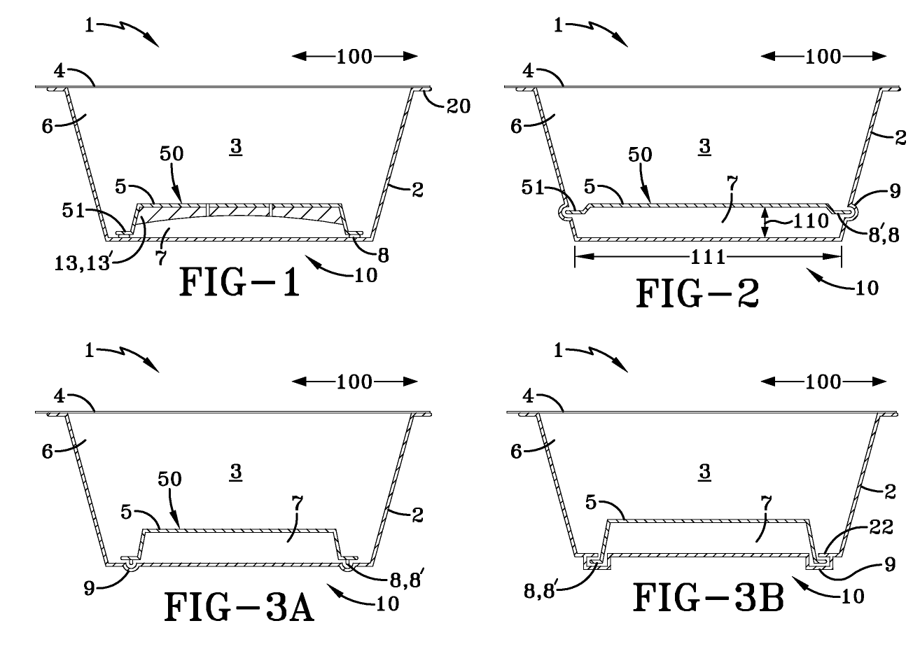

FIG. 1 illustrates a schematic side-on sectional view of a portion capsule 1 according to a first embodiment of the present invention, with the portion capsule 1 having a substantially frustoconical base element 2 which is formed in the manner of a pot and surrounds a cavity 3. The cavity 3 is closed off by a membrane 4. The base element 2 comprises in particular a soft or rigid plastic material. The membrane 4 comprises preferably a thin plastic or aluminium foil. The base element 2 has, in the region of the membrane 4, an encircling fastening flange 20, with the membrane 4 being connected to the fastening flange 20 in a materially joined fashion, in particular by welding or adhesive bonding. Arranged within the base element 2 is a filter element 5 which is produced from a thermoplastic, for example polypropylene. The filter element 5 divides the cavity 3 into a first region 6 and a second region 7. The first region 6 is provided for holding beverage raw material, which for clarity is not illustrated in the figures. The first region 6 is for example filled with coffee powder before the cavity 3 is closed off by the membrane 4. The coffee powder is preferably intensely compressed when it is filled into the first region 6. The second region 7 serves to hold and in particular to collect a beverage extract (not shown) during the extraction process of the portion capsule 1. The portion capsule 1 is provided for insertion into the brewing chamber of a coffee machine (not shown) in which an extraction liquid (for example hot water) is supplied, preferably under high pressure, to the first region 6. Said extraction liquid interacts with the beverage raw material so as to form a beverage extract. The filter element 5 has a multiplicity of filter openings 17 in a filter surface 50 and therefore functions as a sieve for the beverage extract. The beverage extract therefore passes through the filter openings 17 into the second region 7. The second region 7 is delimited by a bottom region 10 of the base element 2, which in the brewing chamber is for example pierced by a puncturing stem of the coffee machine in order to produce an outlet opening for the beverage extract. It is alternatively conceivable for an outlet opening to automatically be formed in the bottom region 10 under the pressure of the extraction liquid, and/or for an outlet opening or an outlet valve to already be implemented in the bottom region. The cross section of the filter openings 17 is selected such that no particles of the beverage raw material pass from the first region 6 into the second region 7. To prevent the filter element 5 from being displaced relative to the base element 2, the portion capsule 1 according to the invention according to the first embodiment has fastening means 8 which are arranged on one of the opposite sides of the base element 2 and which ensure a firm connection between the filter element 5 and the base element 2. A displacement of the filter element 5 relative to the base element 2 for example during storage and during transportation or during the injection of the extraction liquid into the first region 6 at high pressure is therefore prevented. This eliminates the risk of particles of the beverage raw material passing around the filter element 5 and into the second region 7. Furthermore, the portion capsule 1 according to the invention according to the first embodiment has a reinforcement element 13 which extends at least partially substantially parallel to a main plane of extent 100 of the filter element 5, of the membrane 4 or of the bottom region 10. The reinforcement element 13 serves to absorb the forces acting on the filter element 5 during the injection of the extraction liquid into the first region 6 at high pressure or during the compression of the beverage raw material, and to prevent deformation of or damage to the filter surface 50 of the filter element 5. The reinforcement element 13 comprises in particular reinforcement struts 13′ which function as a foundation for the filter surface 50. In the first embodiment, the fastening means 8 comprise, by way of example, a weld seam or an adhesive layer by means of which an encircling flange 51 of the filter element 5 is connected to the bottom region 10 in a materially joined fashion.

FIG. 2 shows a schematic side-on sectional view of a portion capsule 1 according to a second embodiment of the present invention, with the second embodiment substantially corresponding to the first embodiment illustrated in FIG. 1, with a wall 21 of the base element 2 having a preferably encircling groove 9 into which laterally engages a fastening means 8 in the form of an engagement element 8′ of the filter element 5. The engagement element 8′ is therefore fixed in the groove 9 in a positively locking fashion such that a relative movement between the filter element 5 and the base element 2 is prevented. The engagement element 8′ comprises in particular an encircling edge or flange of the filter element 5. The engagement element 8′ and the groove 9 preferably form a latching or click-in connection such that, during the production of the portion capsule, the filter element 5 is pushed into the cavity 3 in the direction of the bottom region 10 until the engagement element 8′ automatically latches into the groove 9. The portion capsule 1 is designed such that, perpendicular to the main plane of extent 100, the filter element 5 has a spacing 110 to the bottom region 10 amounting to 5 millimetres and/or 16 percent of the cross section 111 of the filter element 5 parallel to the main plane of extent 100. The swirl formation in the flow behaviour of the beverage extract in the second region 7 is promoted in this way.

FIGS. 3a and 3b show schematic side-on sectional views of a portion capsule 1 according to a third embodiment of the present invention, with the third embodiment being substantially identical to the first embodiment illustrated in FIG. 1, with the fastening means 8 comprising not a welded or adhesive connection but rather, similarly to the second embodiment, an engagement element 8′ which engages into a groove 9 of the base element 2, wherein in the third embodiment the groove 9 is arranged in the bottom region 10. Here, the engagement element 8′ is held in a positively locking and/or non-positively locking fashion in the groove 9. The engagement element 8′ is for example pressed into the groove 9, as illustrated in FIG. 3a. Alternatively, the engagement element 8′ engages behind an undercut 22 of the base element 2 in the region of the groove 9. This situation is illustrated for example in FIG. 3b. In FIG. 3a, the groove 9 comprises a round cross section, while the groove in FIG. 3b has a rectangular cross section.

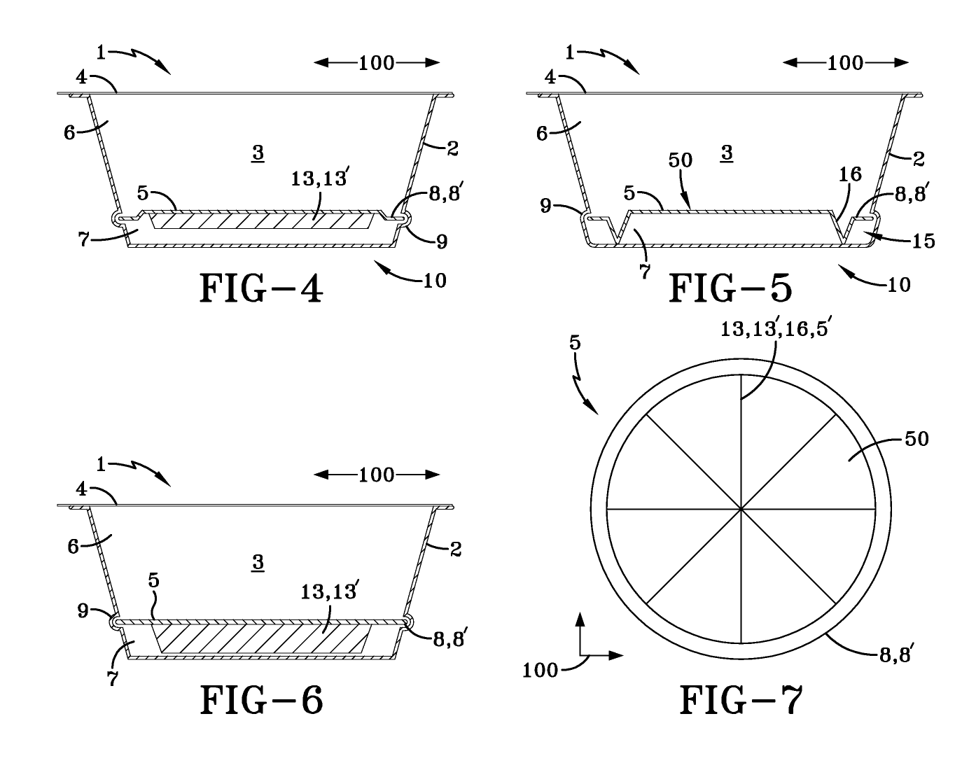

FIG. 4 illustrates a schematic side-on sectional view of a portion capsule 1 according to a fourth embodiment of the present invention, with the fourth embodiment being substantially identical to the second embodiment illustrated in FIG. 2, with the filter element 5 additionally comprising a reinforcement element 13 in the form of reinforcement struts 13′, similarly to the first embodiment.

FIG. 5 illustrates a schematic side-on sectional view of a portion capsule 1 according to a fifth embodiment of the present invention, with the fifth embodiment being substantially the second embodiment illustrated in FIG. 2, with the groove 9 being designed to be significantly wider perpendicular to the main plane of extent 100 and extending substantially to the bottom region 10 of the base element 2. The fastening means 9 is therefore arranged substantially on a side, which is situated opposite the membrane 4, of the base element 2. Furthermore, the filter element 5 comprises an encircling bead 15 which has a V-shaped cross section and which extends between the engagement element 8′ and the filter surface 50 to the bottom region 10. The bead 15 has the purpose of mounting the engagement element 8′ in a resiliently elastic manner relative to the rest of the filter element 5 parallel to the main plane of extent 100, such that the engagement element 8′ can be formed so as to be preloaded in the direction of the groove 9. The engagement element 8′ is accordingly fixed in the groove 9 not only in a positively locking fashion but rather in particular also in a non-positively locking fashion. Furthermore, the filter element 5 is supported on the bottom region 10 by means of the bead 15, such that the filter element 5 is spaced apart from the bottom region 10.

FIG. 6 illustrates a schematic side-on sectional view of a portion capsule 1 according to a sixth embodiment of the present invention, with the sixth embodiment substantially corresponding to the fourth embodiment illustrated in FIG. 4, with the width of the groove 9 perpendicular to the main plane of extent 100 extending over the entire material thickness of the filter surface 50. In said embodiment, the wall of the base element 2 is additionally stabilized by the filter material 5. Here, the filter element 5 has a multiplicity of filter openings 17, with the sum of the cross-sectional areas of all the filter openings 17 making up substantially 1.4 percent of the cross section 111 of the filter element 5 parallel to the main plane of extent 100.

FIG. 7 illustrates a schematic plan view of the reinforcement structure 13 of a filter element 5 of a portion capsule 1 according to a seventh embodiment of the present invention, with the seventh embodiment being substantially similar to the sixth embodiment shown in FIG. 6, with the reinforcement struts 13′ of the reinforcement structures 13 being arranged in a star-shaped configuration in a plane parallel to the main plane of extent 100. Accordingly, FIG. 7 shows in particular the underside of the filter element 5 (that is to say as viewed from the bottom region 10). For clarity, the filter openings 17 are not illustrated.

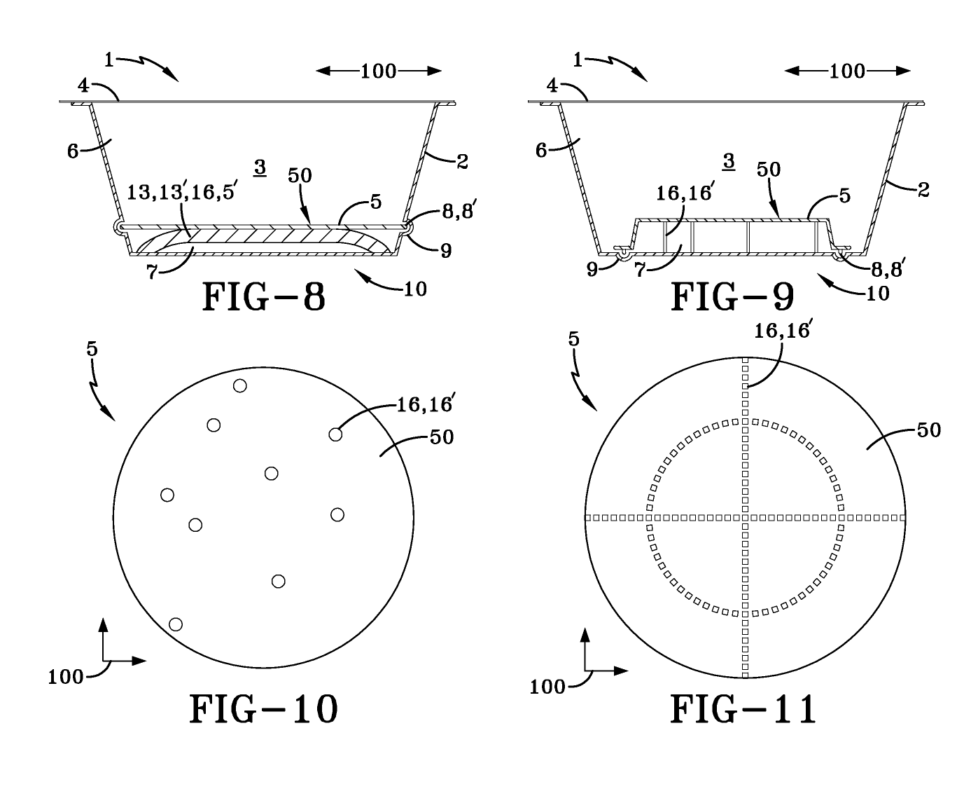

FIG. 8 shows a schematic side-on sectional view of a portion capsule 1 according to the seventh embodiment of the present invention. It can be seen in said perspective that the reinforcement struts 13′ are curved relative to the main plane of extent 100, which is parallel to the membrane 4, such that the end regions of the reinforcement struts 13′ are supported on the bottom region 10. The reinforcement struts 13′ therefore simultaneously comprise support structures 16 which are provided for spacing the filter element 5 apart from the bottom region 10. On account of the curved design of the reinforcement struts 13′, the reinforcement struts 13′ comprise a particularly stable arch structure 5′ in the form of an ellipsoidal shell or spherical shell.

FIG. 9 illustrates a schematic, side-on sectional view of a portion capsule 1 according to an eighth embodiment of the present invention, with the eighth embodiment being substantially identical to the third embodiment illustrated in FIG. 3a, with the filter element 5 additionally having support structures 16 in the form of columns 16′. The columns 16′ support the filter surface 50 with respect to the bottom region 10, such that the filter element 5 is more stable with respect to the action of forces directed perpendicular to the main plane of extent 100. The columns 16′ are arranged so as to be distributed non-uniformly in a plane parallel to the main plane of extent 100.

FIG. 10 illustrates a schematic plan view of a filter element 5 of a portion capsule 1 according to the eighth embodiment of the present invention, with the filter element 5 being illustrated in particular from the underside, that is to say as viewed from the bottom region 10. It can be seen from FIG. 10 that the columns 16′ are arranged so as to be distributed non-uniformly, so as not to adversely affect the swirl formation, or so as to promote the swirl formation, in the beverage extract in the second region 7 during the extraction.

FIG. 11 illustrates a schematic plan view of a filter element 5 of a portion capsule 1 according to a ninth embodiment of the present invention, with the ninth embodiment being substantially identical to the eighth embodiment illustrated in FIG. 10, with the columns 16′ being arranged in a uniform annular and crossed structure.

FIG. 12 illustrates a schematic, side-on sectional view of a portion capsule 1 according to a tenth embodiment of the present invention, with the tenth embodiment being substantially identical to the first embodiment illustrated in FIG. 1, with that side of the filter element 5 which faces towards the bottom region 10 being curved relative to the main plane of extent 100 and therefore being formed as an ellipsoidal or spherical shell or as an arch structure 5′. The groove 9 has a rectangular cross section which extends over the entire width of the filter element 5 and which is arranged on a side, which is situated opposite the membrane 4, of the base element 2. The arch structure 5′ also serves simultaneously as a reinforcement element 13 and as a support structure 16. Also illustrated in FIG. 12, for the first time, are the filter openings 17 of the filter element 5, which filter openings form passage openings for the beverage extract between the first region 6 and the second region 7. In the filter element 5 of the portion capsule 1 according to the tenth embodiment, the filter openings define filter ducts 17′ which extend perpendicular to the main plane of extent 100 from the first region 6 to the second region 7. On account of the arch structure 5′ of that side of the filter element 5 which faces towards the bottom region 10, the filter ducts 17′ at the outer region 101 of the filter element 5 have a greater length than those in the central region 102 of the filter element 5 along the main plane of extent 100. In order to keep the flow resistance as constant as possible over the entire filter surface 50, the cross sections of the filter openings 17 are formed so as to increase in size along a radial direction 100′ from the central region 102 towards the outer region 101.

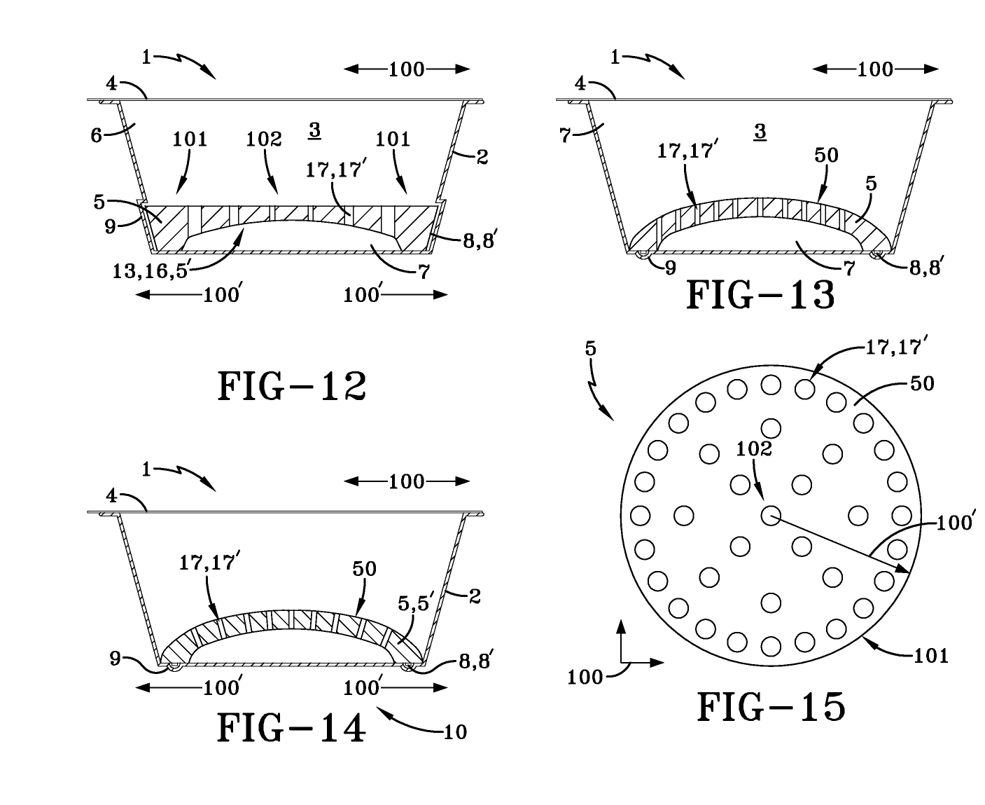

FIG. 13 illustrates a schematic, side-on sectional view of a portion capsule 1 according to an eleventh embodiment of the present invention, with the eleventh embodiment being substantially identical to the tenth embodiment illustrated in FIG. 12, with a side, which faces away from the bottom region 10, of the filter element 5 also being formed so as to be inclined relative to the main plane of extent 100. The entire filter element 5 is therefore designed as an arch structure 5′, and comprises in particular the shape of a spherical shell or dome. Here, the cross sections of the filter openings 17 and also the lengths of the filter ducts 17′ are virtually constant over the entire filter surface 50. Similarly to the third embodiment illustrated in FIG. 3a, the fastening means 8 comprises an encircling engagement element 8′ which engages into a groove 9 formed in the bottom region 10. The filter ducts 17′ extend substantially perpendicularly to the main plane of extent 100. The filter openings 17 or the filter ducts 17′ have in particular a mean cross section of substantially 400 micrometres.

FIG. 14 illustrates a schematic, side-on sectional view of a portion capsule 1 according to a twelfth embodiment of the present invention, with the twelfth embodiment being substantially identical to the eleventh embodiment illustrated in FIG. 13, with the filter ducts 17′ extending substantially perpendicular to the filter surface 50 and not perpendicular to the main plane of extent 100. The beverage extract is therefore collected below the central region 102 of the filter element 5.

FIG. 15 illustrates a schematic plan view of a filter element 5 of a portion capsule 1 according to a thirteenth embodiment of the present invention, with the thirteenth embodiment being substantially identical to the tenth embodiment illustrated in FIG. 12, wherein to compensate for the increasing lengths of the flow ducts 17′ in the radial direction 100′, the frequency of the flow ducts 17′ increases along the radial direction 100′ proceeding from the central region 102 to the outer region 101.

FIG. 16 illustrates a schematic, side-on sectional view of a portion capsule 1 according to a fourteenth embodiment of the present invention, with the fourteenth embodiment being substantially identical to the fourth embodiment illustrated in FIG. 4, with the bottom region 10 being formed in the region of the membrane 4. In this case, the extraction liquid is introduced into the first region through the base element 2, while the beverage extract emerges from the second region 7 through an opening in the membrane 4. It is basically conceivable in all of the embodiments illustrated in FIGS. 1 to 15 for the first region 6 and second region 7 to be interchanged in this way, such that the bottom region 10 is arranged in the region of the membrane 4. Here, the filter openings 17 have in particular a mean cross section of substantially 400 micrometres.

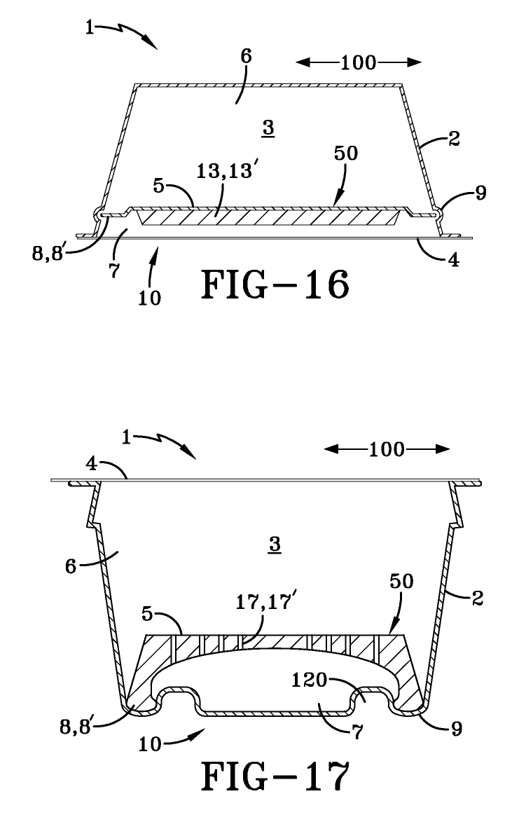

FIG. 17 illustrates a schematic, side-on sectional view of a portion capsule 1 according to a fifteenth embodiment of the present invention, with the fifteenth embodiment being substantially identical to the tenth embodiment illustrated in FIG. 12, with the cross sections of the filter ducts 17′ all being of the same size, and wherein, similarly to the third embodiment illustrated in FIG. 3a, the fastening means 8 comprises an engagement element 8′ which engages into an encircling groove 9 in the bottom region 10 of the base element 2. In the fifteenth embodiment, the groove 9 is formed for example by an encircling bulging 120 of the base element 2 in the direction of the filter element 5 and the wall of the base element 2. The engagement element 8′ engages, in particular in the manner of a pushbutton mechanism, into the annular groove 9 formed in the bottom region 10.

What is claimed is:

1. Portion capsule for producing a beverage, having a substantially frustoconical or cylindrical base element which has a cavity, and having a membrane which closes off the cavity, with a filter element being arranged within the cavity, which filter element divides the cavity into a first region for holding beverage raw material and a second region for holding a beverage extract, characterized in that the filter element is fastened to the base element by at least one fastening means which is arranged substantially in the region of a side, which is situated opposite the membrane, of the base element.

2. Portion capsule according to claim 1, characterized in that the base element has a groove, with the fastening means comprising an engagement element which engages into the groove in a non-positively locking, positively locking and/or materially joined fashion.

3. Portion capsule according to claim 2, characterized in that the groove is formed in a wall and/or in a bottom region of the base element.

4. Portion capsule according to claim 2, characterized in that a latching and/or click-in connection is formed between the engagement element and the groove.

5. Portion capsule according to claim 2, characterized in that the engagement element extends perpendicular to a main plane of extent of the membrane substantially over the entire height of the groove, with the groove preferably extending to the bottom region.

6. Portion capsule according to claim 2, characterized in that an undercut is formed in the region of the groove, which undercut is engaged behind by the engagement element.

7. Portion capsule according to claim 2, characterized in that the cross section of the groove is substantially round or angular.

8. Portion capsule according to claim 2, characterized in that the engagement element is pressed into the groove.

9. Portion capsule according to claim 2, characterized in that the engagement element is releasably connected to the groove.

10. Portion capsule according to claim 1, characterized in that the fastening means are formed in the encircling edge region of the filter element, with a bead being formed between the fastening means and a filter surface of the filter element.

11. Portion capsule according to claim 10, characterized in that the bead extends perpendicular to the main plane of extent to the bottom region and/or in that the bead has a U-shaped or V-shaped cross section.

12. Portion capsule according to claim 1, characterized in that the fastening means comprise a welded connection and/or an adhesive connection.

13. Portion capsule according to claim 1, characterized in that the filter element comprises a reinforcement element.

14. Portion capsule according to claim 13, characterized in that the reinforcement element extends at least partially along a main plane of extent of the filter element.

15. Portion capsule according to claim 13, characterized in that the reinforcement element is arranged perpendicular to the main plane of extent between a filter surface of the filter element and a bottom region of the base element.

16. Portion capsule according to claim 13, characterized in that the reinforcement element comprises reinforcement struts which preferably extend substantially parallel to the main plane of extent.

17. Portion capsule according to claim 16, characterized in that the reinforcement struts are arranged so as to run in a radial direction, and in particular in a crossed or star-shaped configuration, in a plane parallel to the main plane of extent.

18. Portion capsule according to claim 16, characterized in that the reinforcement struts and/or sides, which face towards the bottom region, of the reinforcement struts are formed so as to be curved relative to the main plane of extent, and are formed in particular as an arch structure.

19. Portion capsule according to claim 1, characterized in that a spacing of between 1 millimetre and 10 millimetres, preferably of between 3 millimetres and 7 millimetres, and particularly preferably of substantially 5 millimetres, is provided between the filter element and the bottom region perpendicular to a main plane of extent of the membrane.

20. Portion capsule according to claim 1, characterized in that the spacing between the filter element and the bottom region perpendicular to a main plane of extent of the membrane amounts to between 2 and 40 percent, preferably to between 9 and 28 percent and particularly preferably to substantially 16 percent of the cross section of the filter element parallel to the main plane of extent.

21. Portion capsule according to claim 1, characterized in that the filter element has support structures which are provided for spacing the filter element apart from a bottom region of the base element.

22. Portion capsule according to claim 21, characterized in that the support structures are formed as a multiplicity of columns which extend perpendicular to a main plane of extent from the filter, fastening and/or reinforcement element to the bottom region.

23. Portion capsule according to claim 22, characterized in that the columns are arranged in a uniform, in particular annular, crossed and/or star-shaped pattern, and/or non-uniformly, in a plane parallel to the main plane of extent.

24. Portion capsule according to claim 1, characterized in that the filter element has a central depression.

25. Portion capsule according to claim 1, characterized in that the filter element or at least one side, which faces towards a bottom region of the base element, of the filter element is formed so as to be arched relative to a plane parallel to the main plane of extent.

26. Portion capsule according to claim 25, characterized in that the filter element or at least that side of the filter element which faces towards the bottom region is formed as part of an ellipsoidal shell or spherical shell.

27. Portion capsule according to claim 1, characterized in that the filter element is of substantially round design parallel to the main plane of extent and has a multiplicity of filter openings, with the cross sections of the filter openings increasing outwardly along a radial direction.

28. Portion capsule according to claim 1, characterized in that the filter element has a multiplicity of filter openings, with the frequency of the filter openings increasing outwardly along the radial direction.

29. Portion capsule according to claim 1, characterized in that the filter element has a multiplicity of filter openings which in each case define filter ducts extending through the filter element perpendicular to a filter surface of the filter element, with the lengths of the filter ducts perpendicular to the filter surface increasing outwardly along the radial direction.

30. Portion capsule according to claim 1, characterized in that the filter element has a multiplicity of filter openings which are formed such that the sum of the cross sections of the filter openings amounts to between 0.1 and 10 percent, particularly preferably between 1 and 3 percent and particularly preferably substantially 1.4 percent of the entire cross section of the filter element.

31. Portion capsule according to claim 1, characterized in that the filter element has a multiplicity of filter openings, with the cross sections of the filter openings being in each case of substantially round design and varying along a direction perpendicular to the main plane of extent.

32. Portion capsule according to claim 31, characterized in that the filter openings in each case define filter ducts extending through the filter element perpendicular to the filter surface, with the cross sections of the filter ducts being in each case of substantially constant design in a first partial region, and in each case changing along a direction perpendicular to the filter surface in a second partial region.

33. Portion capsule according to claim 32, characterized in that the second partial region is arranged on a side, which faces towards the bottom region, of the filter element.

34. Portion capsule according to claim 31, characterized in that the cross section of the filter openings and/or of the filter ducts increases in size in the direction of the bottom region.

35. Portion capsule according to claim 1, characterized in that the filter element has a multiplicity of filter openings, with a mean diameter of the filter openings of between 100 and 1000 micrometres, preferably of between 300 and 700 micrometres and particularly preferably of substantially 400 micrometres being provided at least on a side, which faces towards the membrane, of the filter element.

36. Portion capsule according to claim 1, characterized in that the filter element has a multiplicity of filter openings, with the filter openings having a mean diameter of between 800 and 1200 micrometres on a side facing towards the bottom region, and a mean cross section of between 300 and 700 micrometres on a side facing away from the bottom region.

37. Portion capsule according to claim 1, characterized in that the filter element has a multiplicity of filter openings, with the filter openings having, at least on a side facing towards the membrane, a mean diameter which amounts to between 40 and 400 percent, preferably to between 55 and 135 percent and particularly preferably to substantially 80 percent of the spacing between the filter element and the bottom region perpendicular to a main plane of extent of the membrane.

38. The use of a portion capsule according to claim 1 for producing a beverage.
